(19) United States
(12) Patent Application Publication
(10) Pub. No.: US 2007/0057022 A1
(43) Pub. Date: Mar. 15, 2007

(54) Component mounting method and component-mounted body

(75) Inventors: Keiichi Mogami, Kanagawa (JP); Hiroshi Asami, Shizuoka (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(73) Assignee: SONY CORPORATION

(21) Appl. No.: 11/499,358

(22) Filed: Aug. 4, 2006

(30) Foreign Application Priority Data
Aug. 24, 2005 (JP) P2005-242691

(51) Int. Cl. A47J 36/02

(52) U.S. Cl. 228/101

(57) ABSTRACT

A component mounting method configured to mount on a wiring board a surface-mount electronic component that has an electrode terminal on a bonding surface, the method including the steps of preparing the electronic component having a solder layer that covers the electrode terminal, and a resin layer that is provided on the solder layer and has a flux function preparing the wiring board having a projection conductor that is formed on a mounting surface and is to be bonded to the electrode terminal and mounting the electronic component on the wiring board, and implementing reflow of the solder layer so that the projection conductor penetrates the resin layer.

### CROSS REFERENCES TO RELATED APPLICATIONS

The present invention contains subject matter related to Japanese Patent Application JP 2005-242691 filed with the Japanese Patent Office on Aug. 24, 2005, the entire contents of which being incorporated herein by reference.

### BACKGROUND OF THE INVENTION

1. Field of the Invention

The present invention relates to a component mounting method for mounting on a wiring board a surface-mount electronic component that has an electrode terminal on its bonding surface, and to a component-mounted body.

2. Description of the Related Art

In related art, as a method for mounting a semiconductor chip (e.g., an LSI) on a wiring board, a method in which gold (Au) stud bumps are formed on the semiconductor chip as shown in FIG. 6 has been known (refer to e.g. Japanese Patent Laid-open No. Hei 10-275810).

Gold stud bumps 105 are provided on electrode pads 104 of a semiconductor chip 101 (FIG. 6A). On a wiring board 201, lands 204 to be bonded to the gold stud bumps 105 are formed (FIG. 6B). For the mounting of the semiconductor chip 101 on the wiring board 201, solder 205 is applied on the lands 204 of the wiring board 201 (FIG. 6C), and then flux 206 is applied on the solder 205 (FIG. 6D) . Subsequently, the semiconductor chip 101 is disposed over the wiring board 201 with being aligned with the wiring board 201, followed by reflow of the solder 205 for bonding the gold stud bumps 105 to the lands 204 (FIG. 6E) . Since a flux residue 206r is left on the surface of the solder 205 as a result of the reflow, this flux residue 206r is clean-removed (FIG. 6F). Subsequently, the gap between the semiconductor chip 101 and the wiring board 201 is filled with underfill resin 301 (FIG. 6G).

In the above-described method, the gold stud bumps 105 contribute to ensuring of the predetermined gap between the semiconductor chip 101 and the wiring board 201.

As another method, a method in which high-temperature solder bumps are formed on a semiconductor chip as shown in FIG. 7 has been known (refer to e.g. Japanese Patent Laid-open No. Hei 10-284635).

High-temperature solder bumps 108 are provided on electrode pads 104 of a semiconductor chip 101 (FIG. 7A). On a wiring board 201, lands 204 to be bonded to the high-temperature solder bumps 108 are formed (FIG. 7B). For the mounting of the semiconductor chip 101 on the wiring board 201, cream solder 208 is applied on the lands 204 of the wiring board 201 (FIG. 7C). Subsequently, the semiconductor chip 101 is disposed over the wiring board 201 with being aligned with the wiring board 201, followed by reflow of the cream solder 208 for bonding the high-temperature solder bumps 108 to the lands 204 (FIG. 7D). Since a flux residue 209r is left on the surface of the solder 208 as a result of the reflow, this flux residue 209r is clean-removed (FIG. 7E). Subsequently, the gap between the semiconductor chip 101 and the wiring board 201 is filled with underfill resin 301 (FIG. 7F).

In this method, the high-temperature solder bumps 108, which are not melted at the time of the reflow of the solder 208, contribute to ensuring of the predetermined gap between the semiconductor chip 101 and the wiring board 201.

However, in the method in which the gold stud bumps 105 are formed on the electrode pads 104 of the semiconductor chip 101 as described above, there is a problem in that pressurizing in the formation of the gold stud bumps 105 possibly damages insulating films directly below the electrode pads 104.

Furthermore, in the method in which the high-temperature solder bumps 108 are formed on the electrode pads 104 of the semiconductor chip 101, high-temperature solder having high lead (Pb) content is used to form the high-temperature solder bumps 108. Therefore, this method is problematically incompatible with the trend toward lead-free products, which are desired in terms of recent environmental problems.

In addition, these methods involve the need to clean-remove the flux residues 206r and 209r after the component mounting. However, recent trends toward larger-size semiconductor chips, smaller bump pitches and so on make it difficult to completely clean-remove the flux residue. Insufficient removal of the flux residue leads to troubles such as failure of ensuring of adhesion between the solder and underfill resin, and deterioration of the solder bonding parts, and hence results in a decrease in the long-term reliability.

The present invention is made in terms of the above-described problems, and an issue thereof is to provide a component mounting method and a component-mounted body that allow component mounting by a low load and achievement of lead-free products, and involve no need to clean-remove flux.

### SUMMARY OF THE INVENTION

In order to solve the above-described problems, according to an embodiment of the present invention, there is provided a component mounting method configured to mount on a wiring board a surface-mount electronic component that has an electrode terminal on a bonding surface. The method includes the step of preparing the electronic component having a solder layer that covers the electrode terminal, and a resin layer that is provided on the solder layer and has a flux function. The method also includes the step of preparing the wiring board having a projection conductor that is formed on a mounting surface and is to be bonded to the electrode terminal. The method further includes the step of mounting the electronic component on the wiring board, and implementing reflow of the solder layer so that the projection conductor penetrates the resin layer.

The projection conductor is composed of a metal or resin material that is not melted at the time of reflow of solder. Preferably, copper, nickel or the like is employed as the nucleus of the projection conductor, and a metal film with good solder wettability, such as a nickel/gold plated film, is formed on the surface of the nucleus. In component mounting, this projection conductor is brought into contact with the resin layer having a flux function over the bonding surface. The resin layer is softened at the time of solder reflow. Thus, due to the self-weight of the electronic component or application of an adequate load according to need, the peak of the projection conductor penetrates the resin layer so as to reach the solder layer. After the reflow, the solder layer serves as the solder bonding part that bonds the electrode terminal to the projection conductor. The resin layer is cured with surrounding the electrode terminal and the solder bonding part to thereby function as a reinforcing resin layer.

The solder layer can be composed of lead-free solder such as tin solder, tin-silver solder, or tin-silver-copper solder, or a material such as indium. Thus, a lead-free component-mounted structure is realized. Furthermore, the resin layer has a flux function, which eliminates the need to clean-remove flux after reflow. Moreover, the component can be mounted only by use of the self-weight of the component or application of a load lower than conventional loads, and hence damage to the electronic component can be prevented.

Any of publicly-known methods such as coating, printing and depositing can be employed for the formation of the solder layer on the electrode terminal.

It is preferable that the resin layer have tackiness (viscosity) since the tackiness offers an effect of temporal fixing of the component to the wiring board. However, the resin layer is not limited to a layer with tackiness.

The shape of the projection conductor is not particularly limited, but any of a cylindrical column shape, a trapezoidal shape, a cone shape and other geometric shapes can be employed.

The term electronic component encompasses active elements (components) such as semiconductor chips as well as passive elements (components) such as chip capacitors. In addition, the term wiring board encompasses motherboards, interposer substrates, silicon wiring boards, semiconductor integrated circuit boards, etc.

As described above, the aspect of the invention allows a component to be mounted by a low load, which reduces the burden on the component bonding surface. In addition, lead-free products can be achieved, and there is no need to clean-remove flux, which can ensure the reliability of the bonding parts.

### BRIEF DESCRIPTION OF THE DRAWINGS

FIGS. 1A to 1F are sectional views showing an example of a step of processing a semiconductor chip applied in an embodiment of the present invention;

FIGS. 2A to 2E are sectional views showing an example of a step of processing a wiring board applied in the embodiment;

FIGS. 3A to 3D are sectional views for explaining steps of a component mounting method according to the embodiment;

FIG. 4 is a sectional view illustrating the structure of bonding parts of a component-mounted body according to an embodiment of the invention;

FIGS. 5A to 5D are sectional views for explaining a modification of the embodiment as a comparison with a structure in the past;

FIGS. 6A to 6G are sectional views for explaining steps of a component mounting method in the past; and

FIGS. 7A to 7F are sectional views for explaining steps of another component mounting method in the past.

### DETAILED DESCRIPTION OF THE PREFERRED EMBODIMENTS

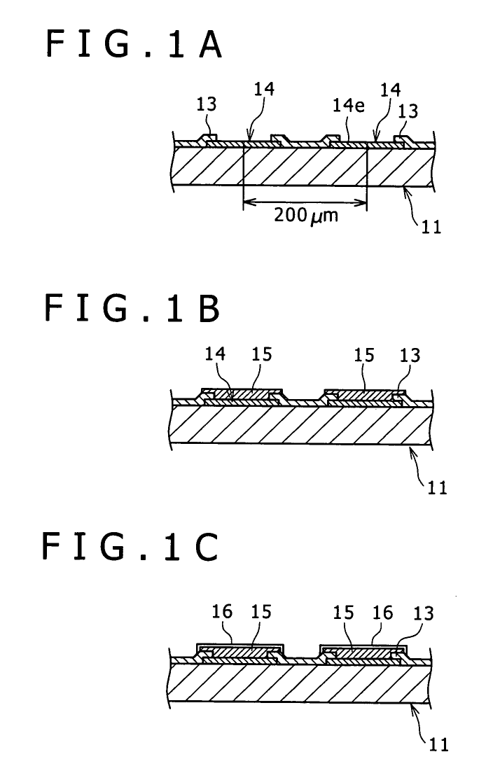

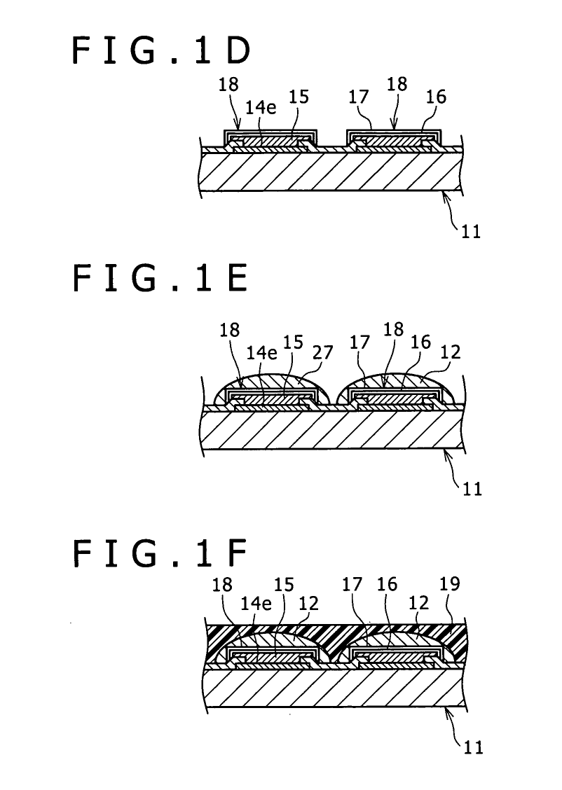

An embodiment of the present invention will be described below with reference to the accompanying drawings. In the description of the following embodiment, a semiconductor chip is taken as an example of the electronic component. FIGS. 1A to 1F are diagrams for explaining a step of preparing a semiconductor chip, and particularly show an example of a step of processing electrode terminals.

As shown in FIG. 1A, electrode pads 14 made of aluminum (Al) are formed on the bonding surface (face) of a semiconductor chip 11. A passivation film 13 is formed in such a manner as to overlap the peripheral parts of the electrode pads 14. The faces of the exposed parts (effective parts) 14e of the electrode pads 14 are at a lower level than the face of the passivation film 13 overlapping the peripheral parts of the electrode pads 14. In this example, the electrode pads 14 are arranged with a pitch of e.g. 200 μm. It should be noted that the scale sizes of the respective components in FIGS. 1A to 1F are not in proportional to the actual sizes. This point also applies to the subsequent drawings.

Electrically conductive films 15 are formed on the electrode pads 14 of the semiconductor chip 11 (FIG. 1B). The conductive films 15 are formed by applying a paste in which silver (Ag) or copper (Cu) ultra-fine particles are dispersed on the exposed parts 14e of the electrode pads 14 and the passivation film 13 overlapping the peripheral parts of the electrode pads 14 by printing, transferring, atomizing, or another method, and then thermally curing the applied paste. Alternatively, the conductive films 15 may be formed through copper plating. Due to the formation of the conductive films 15, terminal regions of which area is larger than that of the exposed parts 14e of the electrode pads 14 are formed.

In order to ensure adhesion between the exposed parts 14e and the conductive films 15, a titanium thin film and a copper thin film may be formed on the exposed parts 14e in advance by a vacuum thin-film forming technique such as sputtering, or alternatively a sintered film of manganese dioxide (MnO₂), which is a metal oxide, may be formed as a primer on the exposed parts 14e in advance. For the formation of the MnO₂ sintered film, a paste-form dispersion liquid in which MnO₂ fine particles are dispersed in an organic solvent is used. The sintered film is formed through evaporating of the organic solvent and sintering of the metal oxide fine particles.

After the formation of the conductive films 15, an absorptive palladium (Pd) catalyst is applied on the conductive films 15, and then an electroless nickel (Ni) plated film 16 and an electroless gold (Au) plated film 17 are formed thereon (FIGS. 1C and 1D), so that bonding pads 18 are formed on the electrode pads 14 (Fig. 1D).

The Al electrode pads are readily melted by the palladium catalyst. Therefore, when the electroless Ni plating and electroless Au plating are implemented, it is required that the Al be replaced by zinc (Zn) in advance. In the present embodiment, however, since there are provided conductive films formed from a paste in which silver or copper ultra-fine particles are dispersed, the melting of the Al electrode pads is avoided without the replacement by Zn.

The thus formed bonding pads 18 correspond to the electrode terminal set forth in the present invention. The face level of the bonding pads 18 is higher than the face level of the passivation film 13 overlapping the peripheral parts of the electrode pads 14. In addition, the area of the upper ends of the bonding pads 18 is larger than that of the exposed parts 14e of the electrode pads 14, which offers a shape that facilitates the bonding to a wiring board.

Subsequently, solder layers 12 are formed on the bonding pads 18 (FIG. 1E). Any of various methods such as plating, printing, coating, and depositing can be applied to the formation of the solder layers 12. The solder layers 12 are formed on the individual bonding pads 18 independently of each other. As the material of the solder layers 12, lead-free tin (Sn)-based solder such as tin solder, Sn—Ag solder or Sn—Ag—Cu solder, or a soldering material such as indium can be used.

Subsequently, on the solder layers 12, a flux resin film 19 composed of thermosetting resin having a flux function is formed by coating (Fig. 1F). The flux resin film 19 is formed on the entire bonding surface (face) of the semiconductor chip 11.

The flux resin film 19 is a paste that has viscosity in its semi-cured state, and is softened at the initial stage of reflow to remove oxides in the solder layers 12. After the reflow, the flux resin film 19 is hardened and remains in the peripheries of the bonding pads 18 so as to serve as a resin layer reinforcing the solder bonding parts.

Examples of the material of the flux resin film 19 include liquid bisphenol epoxy resin to which dihydroxybenzoate and phenolphthalein having functions as a curing agent and flux, and a curing accelerator are added (refer to e.g. Japanese Patent Laid-open No. 2003-105054).

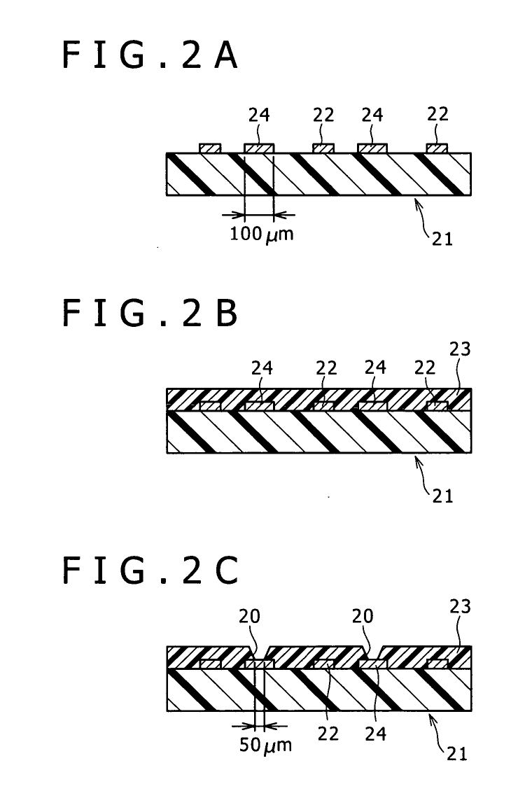

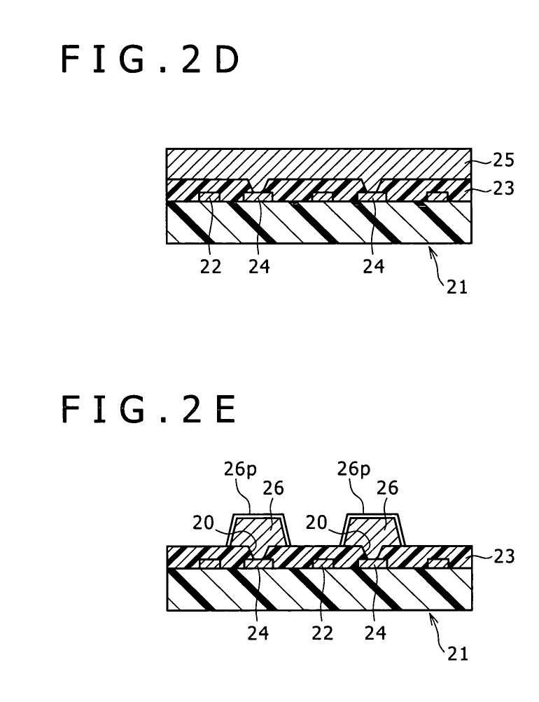

A step of preparing (manufacturing) a wiring board will be described below with reference to FIGS. 2A to 2E.

Referring initially to FIG. 2A, a copper foil deposited on the surface of a base composed of glass epoxy or the like is patterned into a predetermined shape to thereby prepare a wiring board 21 having interconnects 22 and bonding lands 24 formed thereon.

An external insulating resin film 23 is formed on the surface of the wiring board 21 in such a manner as to cover the interconnects 22 and the bonding lands 24 (FIG. 2B). The arrangement pitch of the bonding lands 24 is 200 μm. The external insulating resin film 23 corresponds to the insulating film set forth in the present invention. In the present embodiment, the film 23 is formed of an applied epoxy resin and has a thickness of e.g. 35 μm.

Subsequently, laser processing is implemented for the external insulating resin film 23, so that connecting holes (vias) 20 having such a depth as to reach the bonding lands 24 are formed (FIG. 2C). The diameter of the bottoms of the connecting holes 20 is about 50 μm. The method for forming the connecting holes 20 is not limited to the laser processing, but etching processing with use of photolithography may be employed.

Thereafter, as shown in FIG. 2D, a Cu plated film 25 is formed on the external insulating resin film 23 in such a manner as to fill the connecting holes 20. This Cu plated film 25 has a thickness of e.g. 50 μm, and is formed by combining electroless Cu plating and electrolytic Cu plating.

Subsequently, a circular mask (not shown) that covers regions above the bonding lands 24 is provided on the Cu plated film 25, and then the Cu plated film other than the film directly below the circular mask is removed by wet etching. As the etchant, e.g. a ferric chloride aqueous solution or cupric chloride aqueous solution is used. In this wet etching, side etching proceeds in the regions directly below the circular mask, so that copper nuclei 26 having a truncated cone shape are formed as shown in FIG. 2E at the completion of the etching.

The copper nuclei 26 are connected to the bonding lands 24 via the connecting holes 20, and the peripheral parts of the bottoms of the copper nuclei 26 are supported on the external insulating resin film 23. Ni/Au plated films 26p are formed on the surfaces of the copper nuclei 26 (FIG. 2E). The thus formed copper nuclei 26 formed over the wiring board 21 correspond to the projection conductor set forth in the present invention.

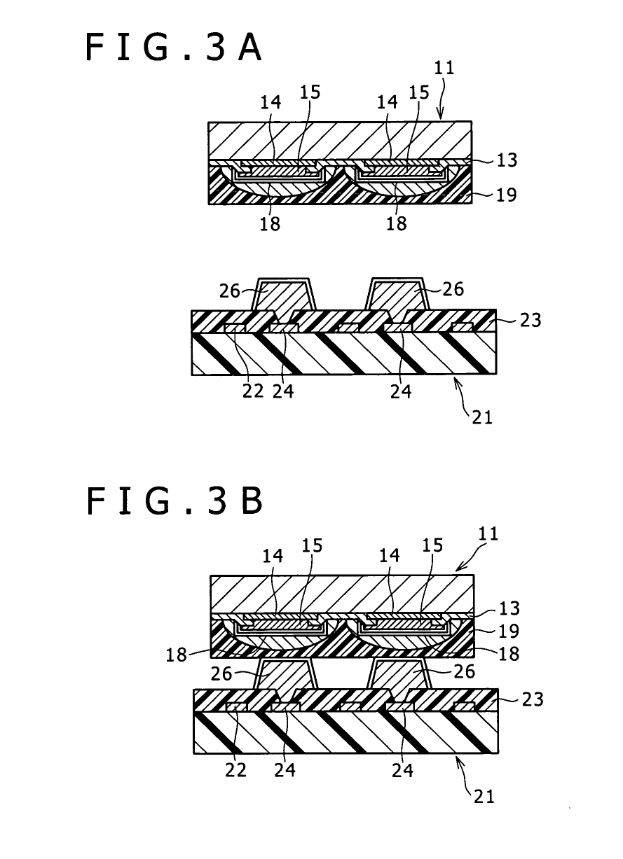

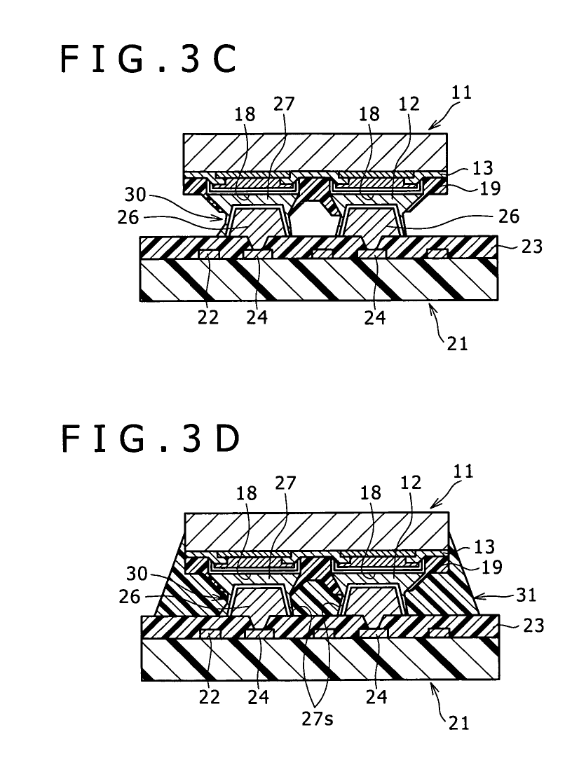

The semiconductor chip 11 and the wiring board 21 manufactured through the above-described steps are bonded to each other as shown in FIGS. 3A to 3D.

Referring initially to FIG. 3A, the bonding pads 18 of the semiconductor chip 11 are aligned with the copper nuclei 26 of the wiring board 21. Subsequently, as shown in FIG. 3B, the semiconductor chip 11 is mounted on the wiring board 21.

The semiconductor chip 11 is supported over the copper nuclei 26 with the intermediary of the flux resin film 19 therebetween. The flux resin film 19 has tackiness (viscosity), and hence offers an effect of temporal fixing of the semiconductor chip 11 onto the wiring board 21. A publicly-known mount device can be used for the mounting of the semiconductor chip 11 onto the wiring board 21.

The semiconductor chip 11 is heated with the state shown in FIG. 3B being kept, to thereby implement reflow of the solder layers 12. In the reflow, the flux resin film 19 is softened due to the heat treatment for the semiconductor chip 11. Thus, the semiconductor chip 11 is lowered down due to its own weight, so that the peaks of the copper nuclei 26 reach the solder layers 12. Furthermore, the flux function of the flux resin film 19 allows removal of oxide films on the surfaces of the solder layers 12.

When the semiconductor chip 11 is further heated, the solder layers 12 are melted and spread around the bonding pads 18 and the copper nuclei 26. As a result, the solder layers 12 reach the peripheries of the bottoms of the copper nuclei 26 and form solder bonding parts 30. Simultaneously, the flux resin film 19 droops down toward the copper nuclei 26. As a result, the flux resin film 19 is cured with surrounding the peripheries of the peaks of the copper nuclei 26 (FIG. 3C).

In the present embodiment, due to the softening of the flux resin film 19 at the time of the reflow, the copper nuclei 26 are buried into the flux resin film 19 so as to reach the solder layers 12. Therefore, the semiconductor chip 11 can be mounted onto the wiring board 21 by a low load, and mounting only by use of the self-weight of the semiconductor chip 11 is also possible. According to experiments by the present inventors, it has been confirmed that, for a 1-cm square semiconductor chip in which the number of bumps is about 2000, a small load of 0.5 g or lower per one bump is possible.

In terms of achievement of mounting of the semiconductor chip 11 by a lower load, it is more preferable that the peaks of the copper nuclei 26 are more acute. However, too acute peaks impose large damage on the bonding pads 18, and induce deformation of the ends of the copper nuclei 26, which makes it difficult to adjust the gap between the semiconductor chip 11 and the wiring board 21. On the other hand, too large a diameter of the peaks of the copper nuclei 26 deteriorates the function of penetrating into the flux resin film (layer) 19, and leads to a small margin of error in the alignment with the bonding pads 18. For that reason, it is preferable that the width (diameter) of the peaks of the copper nuclei 26 be in the range from 30% to 80% of the width of the bonding pads 18.

In order to ensure sufficient mechanical strength of the solder bonding parts 30 that bond the bonding pads 18 to the copper nuclei 26, it is preferable that the amount of solder for forming the solder layers 12 be such that, at the time of the reflow, the solder layers 12 reach the peripheries of the copper nuclei 26, and more preferably reach the bottoms of the copper nuclei 26.

In addition, since the flux resin film 19 can function as a resin layer reinforcing the solder bonding parts 30 after being cured, it is preferable for the flux resin film 19 provided over the semiconductor chip 11 to have such an amount, viscosity and so forth that the flux resin film 19 droops down, due to the softening at the time of the reflow, to such a height as to surround at least the peaks of the copper nuclei 26.

Furthermore, the use of the flux resin film 19 eliminates the need to clean-remove flux residues on the solder bonding parts 30 after the mounting of the semiconductor chip 11. Therefore, the number of manufacturing steps can be reduced, and a decrease in the bonding reliability attributed to insufficiency of cleaning of the flux residues can be avoided. Accordingly, a component-mounted structure can be manufactured sufficiently adequately even when the size of the semiconductor chip 11 and the number of pins (bumps) are increased and the bump pitch is decreased.

Referring next to FIG. 3D, the gap between the semiconductor chip 11 and the wiring board 21 that have been bonded to each other with solder is filled with underfill resin, and then the underfill resin is thermally cured, so that an underfill resin layer 31 is formed. The underfill resin layer 31 surrounds the solder bonding parts 30 so that the solder bonding parts 30 are endowed with enhanced mechanical strength and therefore improved endurance against mechanical and thermal stresses. The flux resin film 19 corresponds to the first resin layer set forth in the present invention, and the underfill resin layer 31 corresponds to the second resin layer set forth in the invention.

In the present embodiment, a material having a lower elastic modulus and a higher thermal expansion coefficient is chosen for the underfill resin layer 31 compared with the flux resin film 19. This material selection can alleviate thermal and mechanical stresses on the solder bonding parts 30 arising due to the difference of the thermal expansion coefficient between the semiconductor chip 11 and the wiring board 21. Furthermore, the peripheries of the bonding pads 18 are protected strongly and thus damage to the semiconductor chip 11 can be avoided. Therefore, the electrode pads 14 that are formed with use of a low-dielectric-constant layer as an interlayer insulating film can be protected sufficiently for example.

Moreover, in order to further enhance the above-described stress alleviation effect, it is preferable that the elastic modules of the external insulating resin film 23 be equal to or lower than that of the underfill resin layer 31, and the thermal expansion coefficient of the external insulating resin film 23 be equal to or higher than that of the underfill resin layer 31. In the present embodiment, the elastic modules of the flux resin film 19, the underfill resin layer 31 and the external insulating resin film 23 is 5 GPa, 2.5 GPa, and 1.2 GPa, respectively.

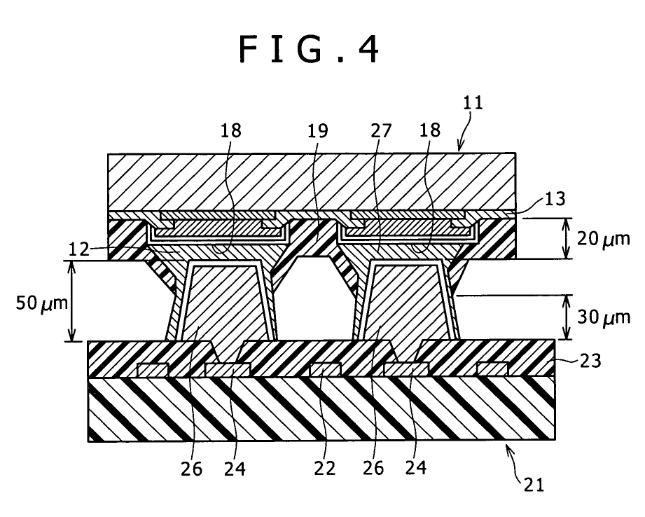

The copper nuclei 26 are not melted at the time of the reflow of the solder layers 12. Therefore, the gap between the semiconductor chip 11 and the wiring board 21 can be adjusted by the height of the copper nuclei 26. In the example shown in FIG. 4, the lower end of the flux resin film 19 drooped down from the semiconductor chip 11 is positioned at a height of 30 μm from the surface of the external insulating resin film 23. The distance from the surface of the external insulating resin film 23 to the peaks of the copper nuclei 26 is 50 μm. The distance from the surface of the passivation film 13 on the semiconductor chip 11 to the peaks of the copper nuclei 26 is 20 μm. Therefore, a gap of 70 μm is ensured between the semiconductor chip 11 and the wiring board 21. The copper nuclei 26 contribute to the ensuring of this gap. In the past, in order to ensure the gap, high-temperature solder bumps composed mainly of lead need to be used, which makes it difficult to realize lead-free solder. In contrast, the formation of the copper nuclei 26 like in the present embodiment eliminates the need to use high-temperature solder, and hence can contribute to a solution of environmental problems.

An embodiment of the present invention has been described above. However, it should be obvious that the invention is not limited thereto but various modifications can be made based on the technical idea of the invention.

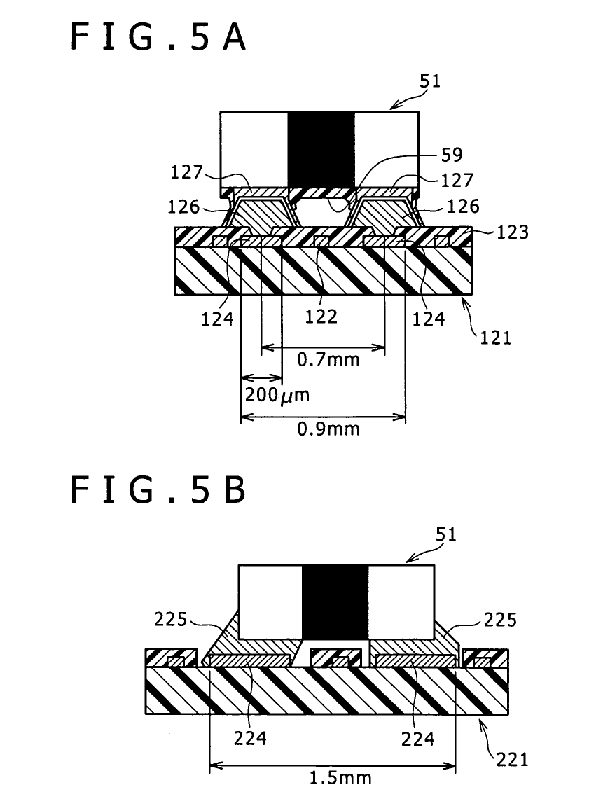

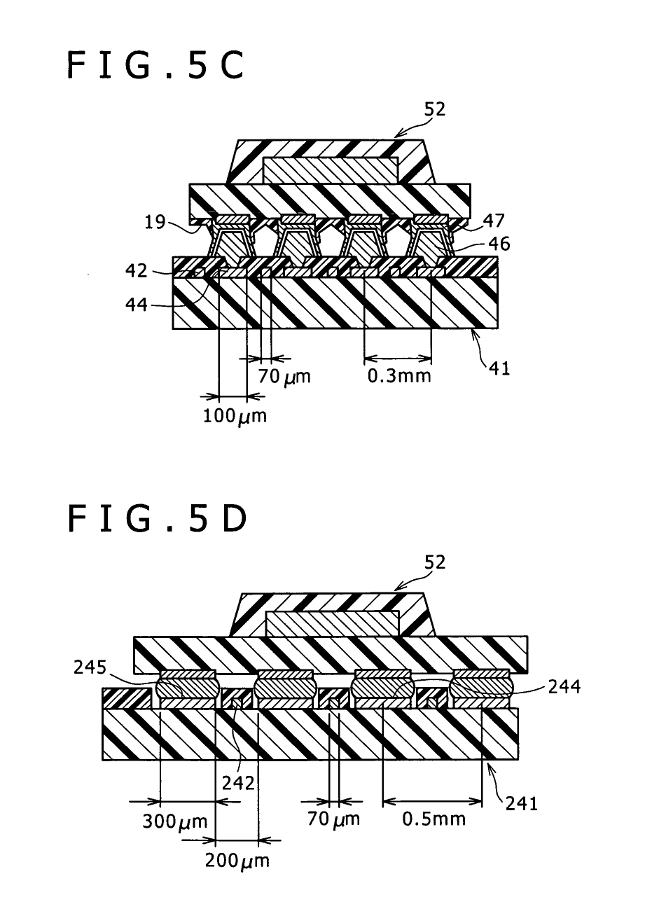

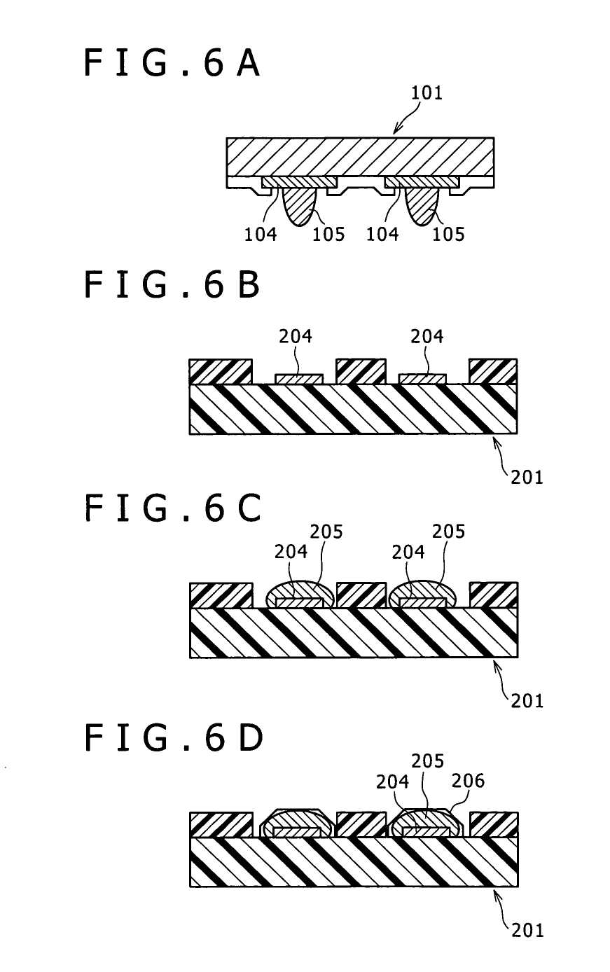

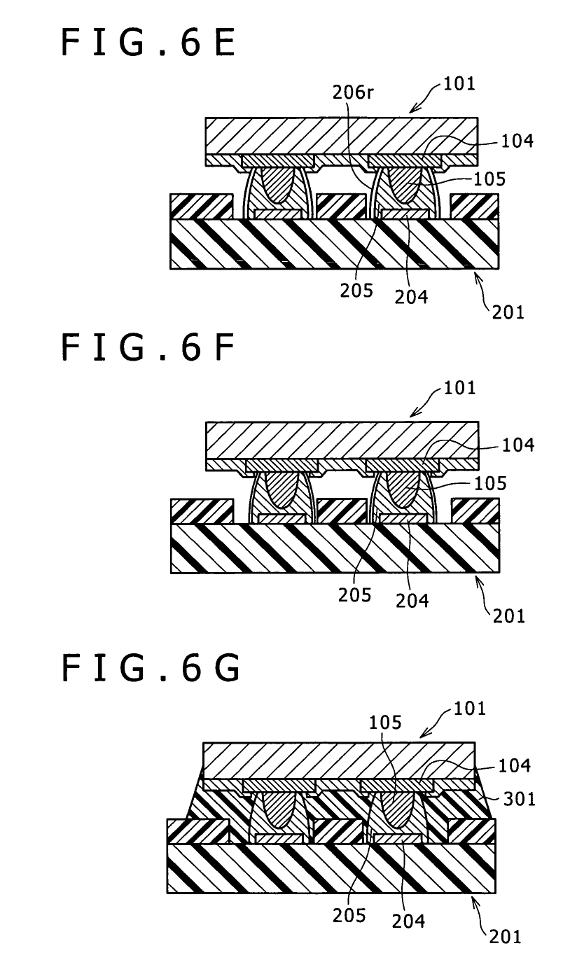

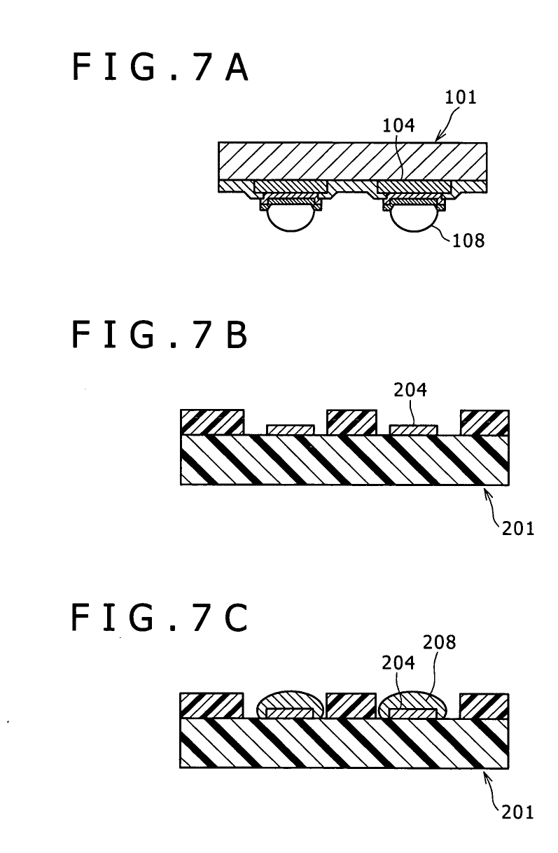

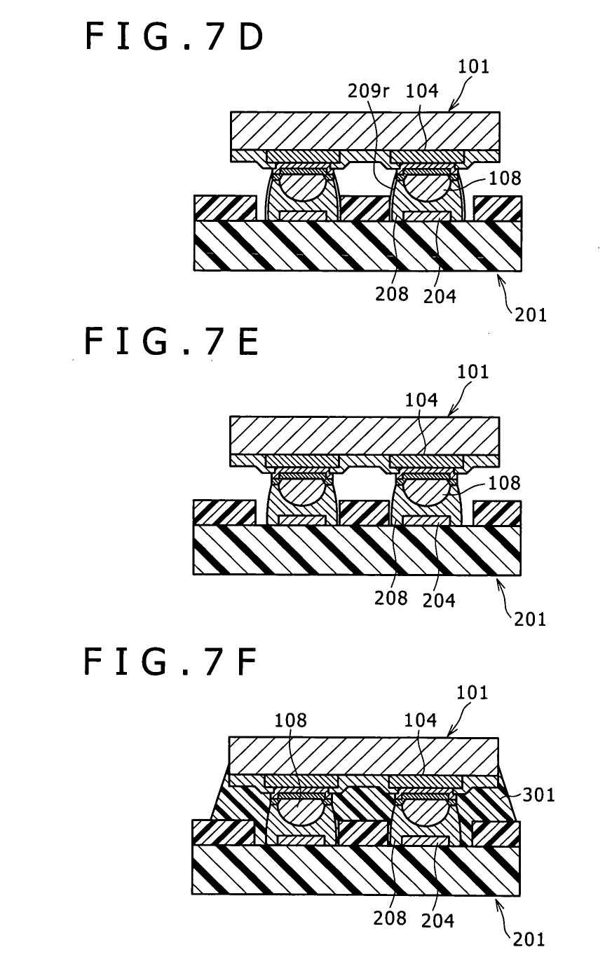

For example, in the above-described embodiment, the semiconductor chip 11 is taken as an example of the electronic component. However, the electronic component is not limited thereto. The invention can be applied also to passive components such as a chip resistor and chip capacitor as shown in FIG. 5A for example. In the example of FIG. 5A, solder layers 127 and a flux resin film 59 are formed on the bonding surface of a component 51. Furthermore, formed on a wiring board 121 are copper nuclei 126 that are connected to bonding lands 124 through an external insulating resin film 123 and are bonded to the solder layers 127.

According to the component mounting method of an embodiment of the present invention, reduction of the component mounting area is also allowed. FIG. 5B illustrates an example in which a component 51 is bonded to bonding lands 224 on a wiring board 221 by an established component mounting method. When a 1005 (vertical 10 mm by horizontal 5 mm) component is used as the component 51, the maximum distance between solder bonding parts 225 is 1.5 mm in the established method. On the contrary, by the component mounting method according to an embodiment of the present invention, the pitch between lands and the maximum separation distance between lands can be decreased to 0.7 mm and 0.9 mm, respectively.

The component mounting method of the invention can be applied also to a package component in which a semiconductor chip is molded with resin. FIG. 5C illustrates an example in which the component mounting method is applied to a semiconductor package component 52 in an LGA (Land Grid Array) form as the electronic component. Specifically, solder layers 47 and a flux resin film 19 are formed on the bonding surface of the component 52. Formed on a wiring board 41 are copper nuclei 46 that are connected to bonding lands 44 and are bonded to the solder layers 47.

FIG. 5D illustrates a component-mounted structure obtained through an established mounting method. Specifically, the component 52 is bonded to bonding lands 244 on a wiring board 241 via solder bonding parts 245. The line width of interconnects 42 and 242 is 70 μm. Under this condition, in the established method, the land width, the land pitch, and the gap between lands are 300 μm, 0.5 mm, and 200 μm, respectively. In contrast, by the component mounting method of the invention, the land width and the land pitch can be decreased to 100 μm and 0.3 mm, respectively.

It should be understood by those skilled in the art that various modifications, combinations, sub-combinations and alterations may occur depending on design requirements and other factors insofar as they are within the scope of the appended claims or the equivalents thereof.

What is claimed is:

1. A component mounting method for mounting on a wiring board a surface-mount electronic component that has an electrode terminal on a bonding surface, the method comprising the steps of:
preparing the electronic component having a solder layer that covers the electrode terminal, and a resin layer that is provided on the solder layer and has a flux function;
preparing the wiring board having a projection conductor that is formed on a mounting surface and is to be bonded to the electrode terminal; and
mounting the electronic component on the wiring board, and implementing reflow of the solder layer so that the projection conductor penetrates the resin layer.

2. The component mounting method according to claim 1, further comprising the step of:
forming a underfill resin layer between the electronic component and the wiring board after bonding of the electrode terminal to the projection conductor.

3. The component mounting method according to claim 1, wherein a width of a peak of the projection conductor is set within a range from 30% to 80% of a width of the electrode terminal.

4. The component mounting method according to claim 1, wherein the preparing the wiring board includes the steps of:
forming an insulating film on a wiring layer on a surface of the wiring board;
forming a via in the insulating film;
forming a conductive layer on the insulating film; and
etching the conductive layer so that the projection conductor is formed on the via.

5. The component mounting method according to claim 1, wherein the solder layer is formed of solder of such an amount that the solder layer spreads toward a periphery of the projection conductor at the time of the reflow.

6. The component mounting method according to claim 1, wherein the resin layer is softened at the time of the reflow of the solder layer and droops down to such a height as to surround at least a peak of the projection conductor.

7. A component-mounted body comprising:
an electronic component that has an electrode terminal on a bonding surface;
a wiring board that has a projection conductor on a mounting surface, the projection conductor being bonded to the electrode terminal with solder;
a first resin layer that is formed around the electrode terminal; and
a second resin layer that fills a gap between the electronic component and the wiring board.
